(19) United States
(12) Patent Application Publication
(10) Pub. No.: US 2026/0052461 A1
(43) Pub. Date: Feb. 19, 2026

(54) System and Method for Reconnecting to a Network

(71) Applicant: ZEBRA TECHNOLOGIES CORPORATION, Lincolnshire, IL (US)

(72) Inventors: Venkata Aneel Kumar Inuganti, Bangalore (IN); Mahesh Kumar Edar, Davenagere (IN); Darpan Majumder, Bangalore (IN)

(21) Appl. No.: 18/805,918

(22) Filed: Aug. 15, 2024

(51) Int. Cl. H04W 48/20; H04W 48/10; H04W 48/16

(52) U.S. Cl. CPC H04W 48/20; H04W 48/10; H04W 48/16

(57) ABSTRACT

An example computing device includes: a first communications interface configured to connect to a network using a first communications protocol; a second communications interface configured to communicate using a second communications protocol; a controller interconnected with the first and second communications interfaces, the controller configured to: in response to detecting a condition indicating the disconnect, broadcast, via the second communications interface, a network request including a network parameter for the network; receive, via the second communications interface, a channel identifier identifying a channel operating according the network parameter; initiate a channel scan on the channel and detect a base station operating on the channel; and control the first communications interface to connect to the base station.

### BACKGROUND

Wireless networks may be serviced by several base stations to which mobile devices can connect based on their location within the wireless network. As users of mobile devices move around, the mobile devices may lose connectivity to the network, for example if the signal is obstructed by structural features or a coverage gap in the network. To reconnect to a network, the device may perform a full network scan, which may be time consuming and increase the amount of time that the device is disconnected

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram of a system for reconnecting to a network.

FIG. 2 is a block diagram of certain internal hardware components of certain devices of FIG. 1.

FIG. 3 is a flowchart of an example method of reconnecting to a network

FIG. 4 is a schematic diagram of an example performance of blocks 320 and 325 of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a device comprising: a first communications interface configured to connect to a network using a first communications protocol; a second communications interface configured to communicate using a second communications protocol; a controller interconnected with the first and second communications interfaces, the controller configured to: in response to detecting a condition indicating a disconnect from the network, broadcast, via the second communications interface, a network request including a network parameter for the network; receive, via the second communications interface, a channel identifier identifying a channel operating according to the network parameter, from a secondary device; initiate a channel scan on the channel and detect a base station operating on the channel; and control the first communications interface to connect to the base station.

Additional examples disclosed herein are directed to a method comprising: detecting a condition indicating a disconnect from a network; in response to detecting the condition indicating the disconnect, broadcasting a network request including a network parameter for the network; receiving a channel identifier identifying a channel operating according to the network parameter; initiating a channel scan on the channel and detecting a base station operating on the channel; and connecting to the base station.

Additional examples disclosed herein are directed to a non-transitory machine-readable storage medium storing instructions which when executed by a processor of a device configure the device to: in response to detecting a condition indicating a disconnect from a network, broadcast a network request including a network parameter for the network; receive a channel identifier identifying a channel operating according to the network parameter; initiate a channel scan on the channel and detect a base station operating on the channel; and connect to the base station.

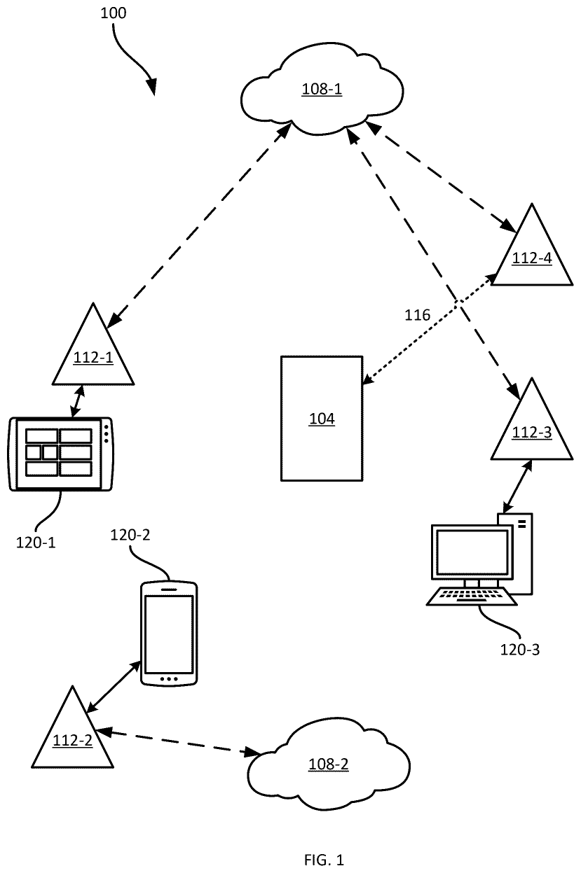

FIG. 1 depicts a system 100 for reconnecting to a network in accordance with the teachings of this disclosure. The system 100 includes a computing device 104 (also referred to herein as simply the device 104).

The device 104 may be a mobile computing device such as a handheld computer, a mobile phone, a tablet, a barcode scanner or the like. The device 104 may be configured to connect to a network, of which two example networks 108-1 and 108-2 are depicted (referred to herein generically as a network 108 and collectively as networks 108; this nomenclature is also used elsewhere herein), each of which may be deployed for wireless communications within a facility, such as a transportations and logistics facility, a warehouse, retail establishment, or other facility. Accordingly, the networks 108 may be wireless local area networks (WLAN) and/or a wireless wide area networks (WWAN), each deployed by one or more base stations, including without limitation one or more base stations and/or cellular base stations, citizens broadband radio service (CBRS) base stations, or the like. In the present example, four base stations 112-1, 112-2, 112-3 and 112-4 are depicted. The base stations 112-1, 112-3 and 112-4 are configured to deploy the network 108-1, while the base station 112-2 is configured to deploy the network 108-2. In other examples, the networks 108 may include more or fewer base stations.

In the present example, the device 104 may be connected to the network 108-1 via a link 116 to the base station 112-4. Since the device 104 may be mobile, the device 104 may be carried about by a user. As the user of the device 104 moves about the facility or other region serviced by the network 108-1, the device 104 may lose connection to the base station 112-4. For example, if the facility includes a coverage gap region such as an elevator or walk-in refrigerator or freezer, or another region which lacks network connectivity due to obstruction of communication to the base stations 112-4, lack of coverage, or the like, the device 104 may briefly lose connectivity to the network 108-1. In other examples, the device 104 may detect a disconnect condition during a preferred network offload (PNO) operation.

When the device 104 exits the coverage gap region, the device 104 may be configured to attempt to reconnect to the network 108-1 with which the device 104 was previously connected prior to entering the coverage gap region. To do so, the device 104 may initiate a full network scan of available channels to identify base stations with which to connect. However, such a full network scan may take time to complete and may therefore extend the time in which the device 104 is disconnected from the network 108-1.

Hence, in accordance with the present disclosure, when the device 104 detects a disconnect condition, particularly one in which the device 104 is disconnected from the network 108-1 for less than a threshold amount of time, the device 104 may initiate a network request using a second communications protocol, such as Bluetooth Low Energy or other short-range wireless communications protocol. In particular, the network request may include a set of network parameters, such as the network identifier and a security protocol, identifying the target network 108-1 with which the device 104 is aiming to reconnect.

Nearby secondary computing devices, such as secondary computing devices 120-1, 120-2, and 120-3 connected to base stations 112-1, 112-2, and 112-3 respectively, may receive the network request including the network parameters. The secondary computing devices 120 may determine whether the corresponding base stations are operating according to the network parameters and respond to the network request. For example, the devices 120-1 and 120-3 may identify that the corresponding base stations 112-1 and 112-3 operate for the network 108-1 and hence may respond to the network request with a channel identifier for the respective channels on which the base stations 124-1 and 124-3 are operating. In contrast the device 120-2 may determine that the corresponding base station 112-2 operates on the network 108-2 rather than the requested network 108-1 and may not generate a response to the network request.

In response to receiving one or more channel identifiers, the device 104 may initiate channel scan(s) on the identified channels to identify the respective base stations 112. The device 104 may then select one of the base stations 112 to connect to. In particular, the network request and response to identify one or more channels to target for a channel scan may be faster than the time to perform a full scan, and accordingly, the device 104 may reduce the amount of time spent in a disconnected state.

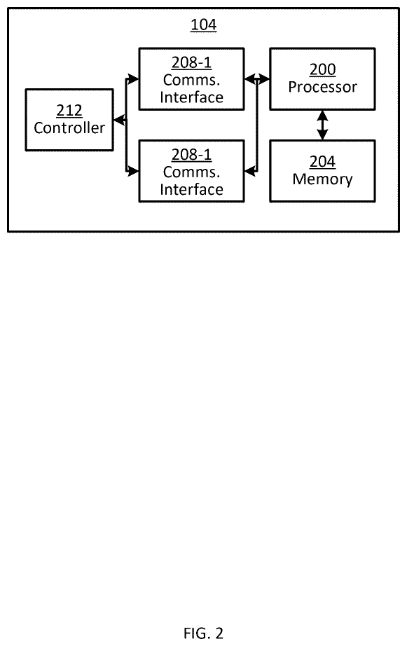

Turning now to FIG. 2, certain internal components of the computing device 104 are illustrated. The device 104 includes a processor 200 interconnected with a non-transitory computer-readable storage medium, such as a memory 204. The memory 204 includes a combination of volatile memory (e.g. Random Access Memory or RAM) and non-volatile memory (e.g. read only memory or ROM, Electrically Erasable Programmable Read Only Memory or EEPROM, flash memory). The processor 200 and the memory 204 may each comprise one or more integrated circuits. The memory 204 stores computer-readable instructions for execution by the processor 200, including one or more applications which, when executed, configure the processor 200 to perform the various functions of the device 104.

The device 104 further includes first and second communications interfaces 208-1 and 208-2 enabling the device 104 to exchange data with other computing devices, such as the base stations 112 and the computing devices 120. The communications interfaces 208 are interconnected with the processor 200 and are controlled by a controller 212. In the presently illustrated example, the controller 212 is depicted independently of the processor 200 and the communications interfaces 208. In other examples, the controller 212 may be integrated with the processor 200 and/or the communications interfaces 208 and/or may include corresponding cooperating communications interface controllers or the like. The communications interfaces 208 include one or more antennas, transmitters, receivers, or the like (not shown) to allow the device 104 to communicate with other computing devices. For example, the first communications interface 208-1 may include suitable components to enable the device 104 to communicate over the networks 108 via the base stations 112. That is, the first communications interface 208-1 may be configured for communications according to a first or primary communications protocol. For example, the first communications protocol may be adapted for communications over local area networks (e.g., Wi-Fi), cellular networks or the like. The second communications interface 208 may further allow the device 104 to communicate with (e.g., to broadcast signals, via a two-way communication link, etc.) other computing devices such as the devices 120 according to a secondary communications protocol, such as a Bluetooth Low Energy protocol, Zigbee or Z-Wave protocols or other suitable short-range wireless communications protocol.

The controller 212 may be a micro-controller, a micro-processor, or other suitable device capable of executing computer-readable instructions to control the components, such as the antennae, transmitters, receivers, and the like, of the communications interfaces 208 to perform the functionality described herein. The controller 212 may comprise one or more integrated circuits and may include and/or be interconnected with a non-transitory computer-readable storage medium storing computer-readable instructions which when executed configure the controller 212 and/or the communications interface 208 to perform the functionality described herein. In particular, the controller 212 may control a network reconnection operation of the device 104.

The device 104 may further include one or more input and/or output devices (not shown) suitable to allow an operator to interact with the device 104. The input devices may include one or more buttons, keypads, touch-sensitive display screens or the like for receiving input from an operator. The output devices may further include one or more display screens, sound generators, vibrators, or the like for providing output or feedback to an operator.

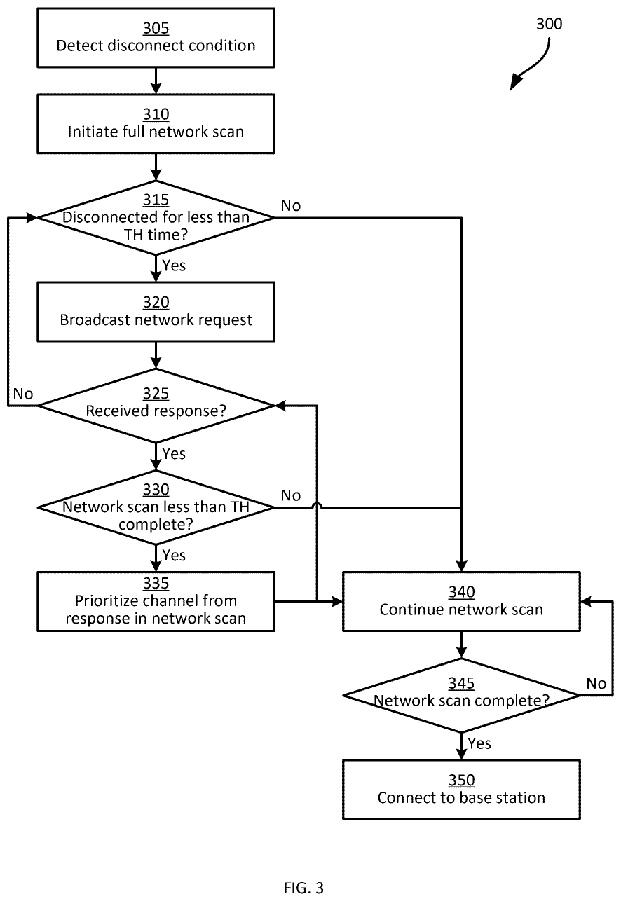

Turning now to FIG. 3, the functionality implemented by the device 104 will be discussed in greater detail. FIG. 3 illustrates a method 300 of reconnecting to a network. The method 300 will be discussed in conjunction with its performance in the system 100, and particularly by the device 104. In particular, the method 300 will be described with reference to the components of FIGS. 1 and 2. In other examples, the method 300 may be performed by other suitable devices or systems.

The method 300 is initiated at block 305, where the device 104 identifies a disconnect condition. The device 104 may identify that it has lost connection to the base station 112-4 to which the device 104 was previously connected to access the network 108-1. The disconnect condition may occur for example if the device 104 enters a region of a coverage gap, such as an elevator or a refrigerator, in which connectivity to the network 108-1 may be obstructed or not suitably covered by the base stations 112.

At block 310, in response identifying the disconnect condition at block 305, the device 104 is configured to initiate a full network scan to scan each of the available channels for a base station 112 operating on the respective channel.

At block 315, further in response to identifying the disconnect condition at block 305, the device 104 determines whether the disconnect condition has been present for less than a threshold disconnect time. For example, the disconnect time may be selected according to an average or expected amount of time in a coverage gap region, such as an average amount of time spent in an elevator or the like. For example, the disconnect time may be about 20 seconds. Beyond the threshold disconnect time, the device 104 may no longer be within range of the same network or other parameters may have changed which may affect the ability of the device 104 to reconnect to the network 108-1.

Accordingly, if the determination at block 315 is negative, that is, the disconnect condition has been detected for more than the threshold disconnect time, then the device 104 proceeds to block 340 to continue the full network scan. That is, rather than reconnecting with support using the secondary communications protocol, the device 104 may proceed with the standard full network scan and connection operation based on the scan results.

If the determination at block 315 is affirmative, that is, the disconnect condition has been detected for less than the threshold disconnect time, then the device 104 proceeds to block 320. At block 320, the device 104 is configured to broadcast, via the second communications interface 208-2, a network request to nearby computing devices 120. In particular, the network request may specify a set of network parameters for the network 108-1 from which the device 104 was disconnected at the disconnect condition detected at block 305. In particular, the device 104 may target reconnection to the same network 108-1, and hence the network parameters may include a network identifier (e.g., a service set identifier (SSID) or the like), security authentication parameters (e.g., a security type such as Wi-Fi Protected Access (WPA), WPA2, 801.1x, or the like) with which the device is capable of authenticating.

At block 325, the device 104 determines whether a response to the network request has been received. In particular, the device 104 may monitor responses receive within a predefined broadcast period. If the determination at block 325 is negative, that is, no responses have been received, then the device 104 returns to block 315 to determine whether the disconnect condition has been present for less than the threshold disconnect time. If the threshold disconnect time has still not passed, the device 104 may continue to iterate through block 320 to broadcast the network request periodically (i.e., based on the broadcast period) until a response is received or until the threshold disconnect time has been reached.

If the determination at block 325 is affirmative, that is, a response is received within the predefined broadcast period, then the device 104 proceeds to block 330. At block 330, the device 104 determines a level of completeness of the full network scan. For example, the device 104 may determine how much time is estimated to remain in the network scan, a percentage completion (e.g., based on the number of channels to be scanned), or the like.

If the level of completeness of the network scan is below a threshold level, then the device 104 proceeds to block 335. At block 335, the device 104 uses the response to modify or prioritize channel scans within the network scan. In particular, in response to receiving the network request, the devices 120 may be configured to respond to the network request when the network 108 with which the respective device 120 is connected matches the network parameters specified in the network request. The device 120 may then generate a response to the network request including a channel identifier for the operating channel of the base station 112 to which the device 120 is connected to access the network.

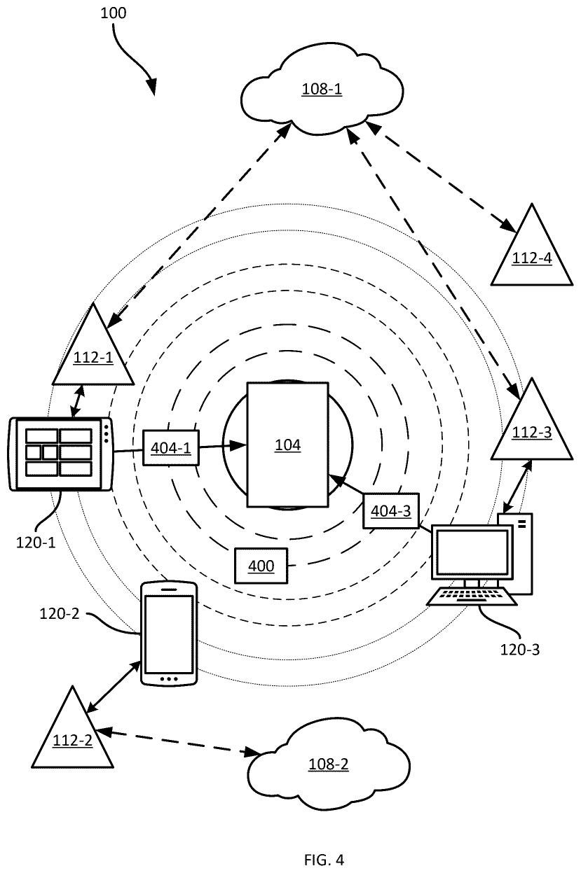

For example, referring to FIG. 4, in response to detecting a disconnect condition (i.e., a disconnection of the link 116 to the base station 112-4), the device 104 is configured to broadcast a network request 400 using the second communications interface 208-1. For example, the network request 400 may be broadcast via Bluetooth Low Energy and may be received by the devices 120. The network request 400 may include an identifier of the network 108-1 with which the device 104 was previously connected prior to the disconnect condition and may additionally include security parameters with which the device 104 is capable of reconnecting to the network 108-1.

Upon receiving the network request 400, the devices 120 may determine whether the network 108 with which they are connected matches the network parameters specified in the network request 400. For example, the devices 120-1 and 120-3 may make an affirmative determination that they are connected to the network 108-1 while the device 120-2 may make a negative determination, since it is connected to the network 108-2.

Accordingly, in response to the network request 400, the device 120-1 may generate a response 404-1 including a channel identifier for the operating channel of the base station 112-1 with which the device 120-1 is connected to access the network 108-1. Similarly, the device 120-3 may generate a response 404-3 including a channel identifier for the operating channel of the base station 112-3 with which the device 120-3 is connected to access the network 108-1. The device 120-2 may not generate a response to the network request.

Accordingly, at block 335, the device 104 may extract, from each response 404, the channel identifier for the operating channels of base stations 112 for the network 108-1 specified in the network request. The device 104 may then modify a scanning sequence for the network scan according to the channel identifiers. In particular, the device 104 may prioritize channel scans for the identified channels, if those channel scans have not yet been performed for the network scan.

The device 104 may then continue to block 340 to continue the network scan according to the modified scanning sequence in which channel scans for the channels identified by nearby computing devices 120 are prioritized. Additionally, the device 104 may return to block 325 to determine if any further responses have been received, and if not, may return to iterate through blocks 315 and 320 to periodically broadcast the network request substantially simultaneously as the performance of the network scan at block 340.

If, at block 330, the network scan is completed above a threshold level of completeness, then the device 104 proceeds to block 340 to continue the network scan as expected and connect to a network based on the scan results. For example, if the network scan is 90% complete, the connection operation based on the scan results may be faster or substantially unaffected by any possible prioritization based on the channels identified by the received responses. Accordingly, the device 104 may ignore the responses to the network request.

At block 340, the device 104 is configured to continue to scan channels as part of the network scan to identify base stations with which the device 104 may connect to access one of the networks 108.

At block 345, the device 104 determines whether the network scan is complete. For example, the device 104 may determine that the network scan is complete when it identifies a suitable base station 112 with which the device 104 may connect to access one of the networks 108. That is, the device 104 may determine the network scan to be complete when the device 104 is capable of connecting to a base station 112, rather than upon completion of each of the channel scans scheduled for the network scan. In such examples, the remaining channel scans scheduled for the network scan may be aborted. In other examples, the device 104 may determine that the network scan is complete upon completion of each of the channel scans.

If the determination at block 345 is negative, that is, the network scan is not complete, then the device 104 returns to block 340 to continue the network scan.

If the determination at block 345 is affirmative, that is, the network scan is complete, then the device 104 proceeds to block 350. At block 350, the device 104 may be configured to connect to a base station 112 based on the scan results from the network scan. In particular, when a channel identified by a nearby computing device 120 is prioritized in the network scan, the amount of time to scan the channel to identify the base station 112 may be reduced, thereby reducing the amount of time that the device 104 is disconnected from network access.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises. . . a”, “has. . . a”, “includes. . . . a”, “contains. . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A computing device comprising:
a first communications interface configured to connect to a network using a first communications protocol;
a second communications interface configured to communicate using a second communications protocol;
a controller interconnected with the first and second communications interfaces, the controller configured to:
in response to detecting a condition indicating a disconnect from the network, broadcast, via the second communications interface, a network request including a network parameter for the network;
receive, via the second communications interface, a channel identifier identifying a channel operating according to the network parameter;
initiate a channel scan on the channel and detect a base station operating on the channel; and
control the first communications interface to connect to the base station.

2. The computing device of claim 1, wherein the controller is configured to broadcast the network request when the condition indicating the disconnect is detected for less than a threshold disconnect time.

3. The computing device of claim 1, wherein the network parameter includes at least one of: a network identifier or security authentication parameters.

4. The computing device of claim 1, wherein the controller is further configured to, in response to the condition indicating the disconnect, initiate a network scan comprising a plurality of channel scans including the channel scan.

5. The computing device of claim 4, wherein to initiate the channel scan, the controller is configured to prioritize the channel scan on the channel identified by the channel identifier within the network scan.

6. The computing device of claim 4, wherein the controller is configured to:
determine a level of completeness of the network scan;
prioritize the channel scan on the channel identified by the channel identifier within the network scan when the level of completeness is below a threshold level of completeness; and
continue the plurality of channel scans in the network scan when the level of completeness is above the threshold level of completeness.

7. The computing device of claim 4, wherein the controller is configured to, in response to identifying the base station, abort a remainder of the plurality of channel scans in the network scan.

8. The computing device of claim 1, wherein the controller is configured to broadcast the network request periodically.

9. A method comprising:
detecting, at a computing device, a condition indicating a disconnect from a network;
in response to detecting the condition indicating the disconnect, broadcasting a network request including a network parameter for the network;
receiving a channel identifier identifying a channel operating according to the network parameter;
initiating a channel scan on the channel and detecting a base station operating on the channel; and
connecting to the base station.

10. The method of claim 9, comprising broadcasting the network request when the condition indicating the disconnect is detected for less than a threshold disconnect time.

11. The method of claim 9, wherein the network parameter includes one or more of: a network identifier; and security authentication parameters.

12. The method of claim 9, further comprising, in response to the condition indicating the disconnect, initiating a network scan comprising a plurality of channel scans including the channel scan.

13. The method of claim 12, wherein initiating the channel scan comprises prioritizing the channel scan on the channel identified by the channel identifier within the network scan.

14. The method of claim 12, further comprising:
determining a level of completeness of the network scan;
prioritizing the channel scan on the channel identified by the channel identifier within the network scan when the level of completeness is below a threshold level of completeness; and
continuing the plurality of channel scans in the network scan when the level of completeness is above the threshold level of completeness.

15. The method of claim 12, further comprising, in response to identifying the base station, abort a remainder of plurality of channel scans in the network scan.

16. The method of claim 9, comprising broadcasting the network request periodically.

17. A non-transitory machine-readable storage medium storing instructions which when executed by a processor of a device configure the device to:
in response to detecting a condition indicating the disconnect from a network, broadcast a network request including a network parameter for the network;
receive a channel identifier identifying a channel operating according to the network parameter;
initiate a channel scan on the channel and detect a base station operating on the channel; and
connect to the base station.

18. The non-transitory machine-readable storage medium of claim 17, wherein the instructions further configure the device to broadcast the network request when the condition indicating the disconnect is detected for less than a threshold disconnect time.

19. The non-transitory machine-readable storage medium of claim 17, wherein the instructions further configure the device to:
in response to the condition indicating the disconnect, initiate a network scan including a plurality of channel scans; and
to initiate the channel scan, prioritize the channel scan on the channel identified by the channel identifier within the network scan.

20. The non-transitory machine-readable storage medium of claim 18, wherein the instructions further configure the device to:
in response to the condition indicating the disconnect, initiate a network scan including a plurality of channel scans;
in response to receiving the channel identifier, determine a level of completeness of the network scan;
prioritize the channel scan on the channel identified by the channel identifier within the network scan when the level of completeness is below a threshold level of completeness; and
continue the plurality of channel scans in the network scan when the level of completeness is above the threshold level of completeness.
